(19) United States
(12) Patent Application Publication
(10) Pub. No.: US 2010/0079679 A1
(43) Pub. Date: Apr. 1, 2010

(54) SYSTEM AND METHOD OF POWER MANAGEMENT IN CONDITIONAL ACCESS BASED RECEIVERS

(75) Inventors: Antin U. KULCZYCKYJ, Richboro, PA (US); Edwin R. Meyer, Princeton, NJ (US); Daniel E. Mocelo, Marlton, NJ (US); Larry G. Phillips, Swedesboro, NJ (US)

Correspondence Address: MCDERMOTT WILL & EMERY LLP, 600 13TH STREET, NW, WASHINGTON, DC, 20005-3096, US

(73) Assignee: PANASONIC CORPORATION

(21) Appl. No.: 12/570,497

(22) Filed: Sep. 30, 2009

Related U.S. Application Data
(60) Provisional application No. 61/101,366, filed on Sep. 30, 2008.

(51) Int. Cl. H04N 5/63

(52) U.S. Cl. 348/730; 348/E05.127

(57) ABSTRACT

An integrated cable-ready digital TV receiver includes a digital TV receiver system, a cable receiver system, a power control system for controlling a first power supply to the digital TV receiver system and a second power supply to the cable receiver system. The power control system is configured to control the first and second power supply according to a condition including a first condition and a second condition of the integrated cable-ready digital TV. In the first condition, the power control system supplies the first power to the digital TV receiver system but does not provide the second power to the cable receiver system. In the second condition, the power control system supplies the first power to the digital TV receiver system and the second power to the cable receiver system.

### RELATED APPLICATION

This application claims the benefit under 35 U.S.C. §119(e) of U.S. Provisional Application No. 61/101,366 filed Sep. 30, 2008.

### TECHNOLOGY FIELD

The present disclosure relates to an integrated cable-ready Digital Television (DTV) receiver in which a DTV receiver is integrated with a functionality contained in a digital cable Set Top Box (STB). Specifically, the present disclosure relates to a system and a method of reducing power consumption in the integrated cable-ready DTV receiver.

### BACKGROUND

Analog NTSC television broadcasting was shut down on Jun. 12, 2009. Consumers dependent on over the air broadcasting must buy a new TV or a converter box to receive digital broadcasting based on the ATSC standard. The advantages of DTV include the ability to transmit high definition video, provide more programs, and provide high quality multi-channel audio.

Cable systems started developing DTV technology in the mid-nineties. Digital cable systems have been deploying value added services which are enabled by digital transmission methods. Examples of these services include Video-On-Demand (VOD) and Pay-Per-View (PPV). Both of these services provide a lucrative income stream for the cable companies because they are based on impulse spending. To be cost effective, these services need to be initiated and/or controlled by the viewers. Typically the programs available for purchase are displayed on the television screen in a listing format or menu. The consumer is able to navigate through the menus displayed on screen by means of keys that are provided on a remote control hand held device. The STB communicates by digital means to the cable company's automated systems, commonly known as the headend, to process the user's request. All of these actions are controlled by proprietary software which is resident in non-volatile memory inside the STB. As these methods evolved over time, a number of de-facto standards emerged from competitor companies. STBs made by these competitor companies are not compatible and can not interoperate.

Conditional access (CA) determines the services or programs that can be accessed based on packages or subscription tiers that have been purchased by the subscriber. CA methods changed dramatically as the cable television industry evolved. Early CA systems tended to be proprietary to a particular manufacturer. The various methods were directly embedded into the manufacturer's cable STB products. STBs made by competing manufacturers did not operate unless they were connected to the cable system headend equipment for which they were designed.

It was recognized by Congress that the proprietary nature of cable system equipment had led to a near-monopoly by two companies. The Telecommunications Act of 1996 authorized the FCC to separate security and navigation functions. CableLabs®, the cable industry's research arm, developed a specification for a removable security module called a Point of Deployment (POD) module that was later renamed a CableCARD™. This module was actually designed and built by the companies that controlled the cable CA. All other aspects of the STB could then be designed by consumer electronics companies and would be interoperable on any headend with the correct CableCARD™ installed for that headend. This opened the door for integrated cable-ready DTV receivers that include a CableCARD™ slot. For consumers the obvious benefit was the elimination of the conventional cable set top box and the associated wiring.

The CableCARD™ is typically physically identical to a PCMCIA module, commonly used to contain a variety of peripheral devices for the expansion of laptop computers. The CableCARD™ is inserted into a cable receiver device that is generically referred to as a Host. The CableCARD™ contains proprietary hardware and software that are required for CA decryption, MPEG transport stream (TS) encryption for the CARD-to-Host interface, and to process messages between the cable system headend and the subscriber's receiver.

The first commercially available OpenCable devices, certified by CableLabs®, had several limitations. Communications between the headend and the OpenCable device were uni-directional; the headend could send messages to the device but the device could not send messages back to the headend. The communications technology was based on QPSK modems not the newer DOCSIS (Data Over Cable Service Interface Specification) Settop Gateway (DSG) technology. Finally these early devices could only process one TS due to the limitations of the CableCARD™. This original CableCARD™ implementation came to be called an S-CARD where “S” denotes single stream. A new CableCARD™ was developed for a more advanced receiver specification. This new CableCARD™ is referred to as an M-CARD because it supports multiple transport streams. This new card also provides support for bidirectional communications for both QPSK modems and DSG.

### SUMMARY

Conventional digital cable STBs are designed with standard composite or component video outputs but do not have any means of directly displaying the video output signals. Power is applied to all of the internal circuitry during operation. For these products it is not necessary to be concerned with multiple powered down system states.

The need for system and method of the present disclosure was created by the advent of integrated cable-ready DTV receivers. In an integrated cable-ready DTV receiver, in which a STB is integrated into a DTV receiver, it is not always necessary to provide power to the STB portion. However, it is inconvenient for a user to turn on the STB manually when the user desires to see the programs of cable TV. While it would be possible to always provide power to both the DTV receiver and the STB, it is not desirable in terms of reducing power consumption.

The present disclosure is based on the concept of controlling the power state of subsystems in an integrated cable-ready DTV receiver based on whether a CableCARD™ is present. When the television is in the off state with a CableCARD™ present, that portion of the television associated with communications between the CableCARD™ and the cable headend must be continuously powered so that downstream messages from the cable company headend can be received and upstream messages can be sent. Other portions such as the television display and video generation subsystem can be powered down. When no CableCARD™ is present, then the system is placed in a complete power down state. This complete power down state would be used on a regular basis by customers who purchased a CableCARD™ capable television but do not use a CableCARD™.

Accordingly, one exemplary embodiment of the present disclosure may include an integrated cable-ready digital TV receiver comprising a digital TV receiver system, a cable receiver system, a power control system for controlling a first power supply to the digital TV receiver system and a second power supply to the cable receiver system. The power control system may be configured to control the first power supply and second power supply according to a condition including a first condition and a second condition of the integrated cable-ready digital TV. In the first condition, the power control system may supply first power as the first power supply to the digital TV receiver system but does not supply second power as the second power supply to the cable receiver system. In the second condition, the power control system may supply the first power to the digital TV receiver system and the second power to the cable receiver system.

The integrated cable-ready digital TV receiver may further comprise a security module receiver for receiving a security module and a condition detection unit for determining the conditions of the integrated cable-ready digital TV. The security module may be used for authorization, decryption or de-scramble of programs processed by the cable receiver system. The condition detection unit may be configured to determine the integrated cable-ready digital TV is in the first condition when the condition detection unit does not detect the presence of the security module in the security module receiver, and the condition detection unit may also be configured to determine the integrated cable-ready digital TV is in the second condition when the condition detection unit detects the presence of the security module in the security module receiver.

It is noted that the second power may include a main power for operating the cable receiver system and a standby power, which is a minimum power for maintaining communications between the security module receiver included in the cable receiver system and the condition detection unit. Thus, in the first condition, the power control system may supply the first power to the digital TV receiver system and the standby power to the cable receiver system, but may not supply the main power to the cable receiver system. Alternatively, in the first condition, the power control system may supply no power to the cable receiver system.

The present disclosure is further directed to a method for controlling a power supply in an integrated cable-ready digital TV receiver comprising a digital TV receiver system, a cable receiver system and a power supply system. The method may comprise a step of detecting whether the integrated cable-ready digital TV receiver is in a first condition or in a second condition. When the integrated cable-ready digital TV receiver is detected as being in the first condition, first power as a first power supply is supplied to the digital TV receiver system from the power supply system but a second power as a second power supply is not supplied to the cable receiver system. When the integrated cable-ready digital TV receiver is detected as being in the second condition, the first power is supplied to the digital TV receiver system and the second power is supplied to the cable receiver system from the power supply system.

Exemplary embodiments of applications/devices to which the receiver and method of the present disclosure is applicable, include, but are not limited to: (1) a television receiver with tuner, digital MPEG video decoder, digital audio decoder, etc; (2) an industry standard PCMCIA card slot capable of supporting the signaling requirements of the CableLabs® CableCARD™ module; (3) a microprocessor based controlling system which among other duties polls or receives asynchronous messages from self contained functional subsystems within the receiver; (4) a collection of resident functional modules e.g. cable modem, quadrature phase shift keying (QPSK) demodulator, quadrature amplitude modulation (QAM) demodulator, etc. that together comprise an integrated cable-ready DTV receiver; (5) a power supply and multiple power switches for each of the subsystems that can be placed into standby or powered down modes; (6) an infrared (IR) receiver and remote device with Power On/Off and other controlling keys; (7) a software algorithm programmed to determine the system's powering state requirements based on inputs from modules that are permanently resident as well as configurable and/or optional expansion modules that may be inserted into the receiver at any time.

Further, another exemplary embodiment of the present disclosure may include a system comprising a plurality of subsystems and a power control system configured to determine how to supply power to the plurality of subsystems according to presence of a removable device within the system. The removable device may be a security device utilized for authorization, decryption or de-scramble of information. The power control system may supply power only to a part of the plurality of subsystems when the power control system fails to detect the removable device. The determination of how to supply power to the plurality of subsystems is made based on the type of the removable device present within the system. The power control system may further be configured to supply power to a whole of the system when the power control system detects the presence of the removable device within the system. The subsystems may comprise a first subsystem and a second subsystem, and the power control system supplies power only to the first subsystem when the power control system fails to detect the presence of the removable device within the system, and the power control system supplies power to the first and second subsystems when the power control system detects the presence of the removable device within the system.

Yet another exemplary embodiment of the present disclosure may include a power control system comprising a plurality of subsystems and a power control system configured to dynamically change power supplied to the plurality of subsystems according to an internal status of the system, for example, presence of a removable device within the system and the type of the removable device. The power control system may dynamically change the power supply among a fully powered state in which power is supplied to the whole system, a standby state in which power is supplied to a part of the plurality of subsystems, and a no-power state in which no power is supplied to the system except the power control system. The power control system may be further configured to dynamically change the power supplied within the system according to a requirement from at least one of the plurality of the subsystems. The power control system may dynamically change the power supplied within the system according to a configuration of at least one of the plurality of subsystems.

### BRIEF DESCRIPTION OF THE DRAWINGS

FIG. 1 is an exemplary block diagram of the device of the present disclosure incorporated in an integrated cable-ready DTV receiver.

FIG. 2 is an exemplary state diagram of the power control embodied in this disclosure.

### DETAILED DESCRIPTION OF THE EMBODIMENT

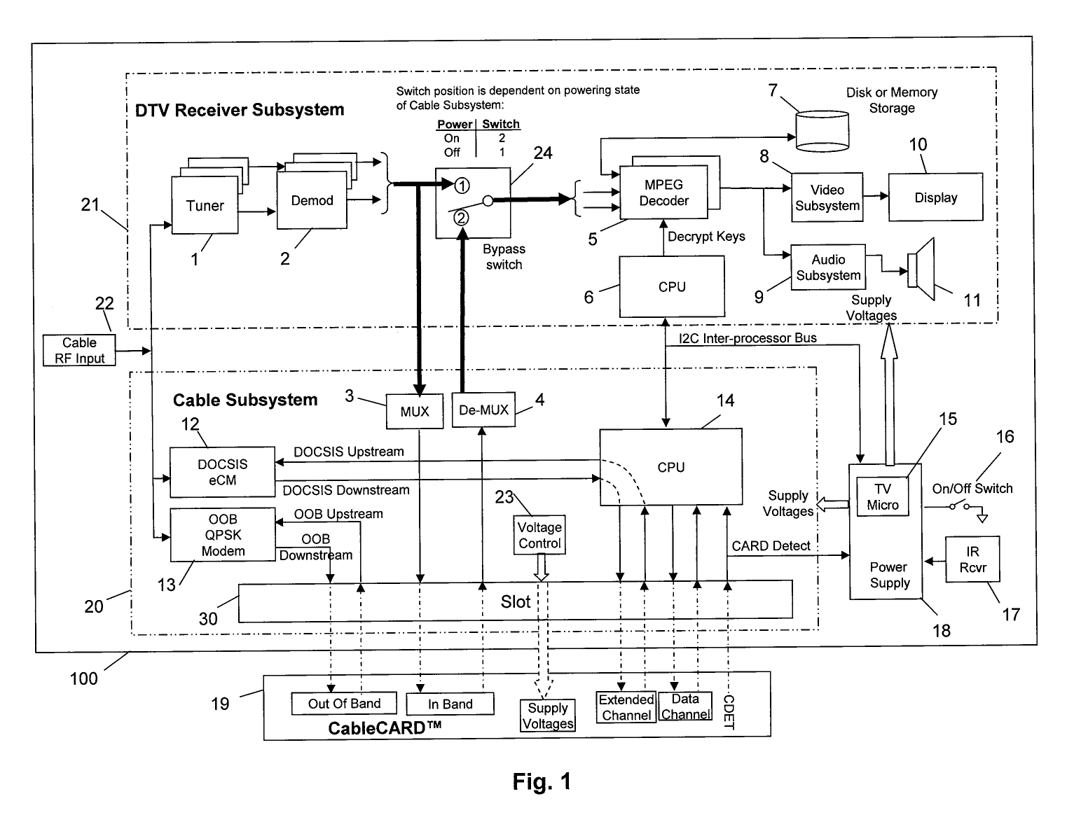

One exemplary embodiment of the present disclosure may be found in an integrated cable-ready DTV receiver 100 as shown in FIG. 1. The device may be integrated into one system comprising subsystems or may include separate subsystems that are separate, self contained products interconnected with standard audio or video cabling. Those subsystems are grouped together as a DTV Receiver Subsystem 21 and a Cable Subsystem 20 as shown in FIG. 1.

The Cable radio frequency (RF) Input 22 is split so that the entire RF spectrum is available to the DTV Receiver Subsystem 21 and to the Cable Subsystem 20. The DTV Receiver Subsystem 21 together with the necessary power supply circuitry within the Power Supply 18 comprises the complete set of functional modules that are sufficient to tune and view unencrypted digital television programs. Hereinafter, the DTV Receiver Subsystem 21 is described first.

The RF signals transmitted from the cable company's headend (not shown) are presented to tuner 1 of the DTV Receiver Subsystem 21. As an optional configuration, the DTV Receiver subsystem 21 may include multiple tuners/demodulators for the cases of providing picture-in-picture and/or being able to display one program while recording another. The tuner 1, under control of the CPU 6, provides the capability to filter out all signals and noise that are present in the entire frequency bandwidth of the incoming signals so that only the tuned channel signal is passed to the demodulator (Demod) 2. It is also the responsibility of the tuner 1 to apply the necessary gain and equalization to maintain a constant amplitude signal to the demodulator 2 as the incoming signal at the cable input 22 will tend to drift due to the physical properties of a transmission medium. The output of the tuner 1 is an Intermediate Frequency (IF) modulated signal. The demodulator 2 further processes the signal to remove the high frequency modulation components and recover a TS. The demodulator 2 is controlled by the CPU 6 as it needs to make decisions about the various modulation modes that are allowable for the carriage of DTV signals. It is also the role of the demodulator 2 to detect and correct bit errors in the incoming TS.

The bypass switch 24 serves as a Single Pole Double Throw (SPDT) switch for one or more TS output from the demodulator 2. The bypass switch 24 is required for both S-CARD and M-CARD based products. The switch position is dependent on the powering state of the Cable Subsystem 20. When the Cable Subsystem 20 is off (i.e., the CableCARD™ is not present), the switch is in position 1 connecting the TS from the demodulator 2 to the MPEG decoder 5. This permits the integrated cable-ready DTV receiver 100 to operate as a DTV receiver. The Cable Subsystem 20 and the CableCARD™ 19 are bypassed. When the Cable Subsystem 20 powers on (i.e., due to a CableCARD™ insertion), the switch is in position 2 breaking the direct connection between the demodulator 2 and the MPEG decoder 5. The TS is now routed through a multiplexer (Mux) 3, into the CableCARD™ 19, out of the CableCARD™ 19 and into a de-multiplexer (Demux) 4, and finally to the MPEG decoder 5. The multiplexer 3 and the de-multiplexer 4 will be described in more detail below.

The MPEG decoder 5 may include TS, video, and audio decoders that are specified in ISO/IEC 13818-1, -2, -3, respectively. The TS is composed of compressed video and audio streams, individually called elementary streams (ES), which have been divided into packets to form packetized elementary streams (PES). The PES packets are encapsulated into a TS packet as the data payload. The TS packet is, for example, 188 bytes in length. The first byte is called a packet identifier (PID). All of the TS packets for an ES have the same PID value. A TS may contain several programs. The programs are typically composed of one video ES and one or more audio ES. A data structure in the TS identifies the PID values associated with each program. These PID values are used to filter the packets belonging to a particular program. This is referred to as PID filtering and may be performed by the TS decoder inside the MPEG decoder 5. Transport streams with encrypted services also carry Entitlement Control Messages (ECM) streams containing information pertinent to the conditional access system. The ES packets may be marked as being encrypted by the two scrambling control bits that immediately follow the 13-bit PID field. An active state of the scrambling control bits causes a decryption or de-scramble of the remainder of the bits that follow within the packet. The decryption may be performed by applying the key codes that are presented to the MPEG decoder 5 by the CPU 6.

The video is decoded in the video decoder inside the MPEG decoder 5 to produce a series of pictures that are stored in a dedicated area of memory known as a frame buffer(s). A frame buffer is read at the appropriate time to reconstruct a video image in the Video Subsystem 8. Such industry standard video signaling methods as composite, component, RGB, HDMI, etc. are typically used. The video signal is applied to a display 10. Typical display technologies in use today for High Definition DTV receivers (HDTV) may include plasma, liquid crystal display (LCD), or projection TV.

There are many audio compression standards including, but not limited to, MP1, MP2, MP3, and AC-3 (Dolby Digital). The first step in recreating the audio portion of the program is by decoding the audio ES by the audio decoder inside the MPEG decoder 5. The audio is still in digital form and must be converted to analog by a digital to analog converter (DAC), then amplified within the audio subsystem 9 and reproduced by a speaker 11.

The above paragraphs provide a description of the DTV Receiver Subsystem 21. The Cable Subsystem 20 provides additional functionality required for tuning and viewing encrypted cable programs, VOD, and PPV. The Cable Subsystem 20 is described next.

The signaling between the headend and the Cable Subsystem 20 is commonly known as out-of-band (OOB) and can be unidirectional or bidirectional. Downstream is defined as messages originating from the cable company headend and sent to the Cable Subsystem 20. Upstream is defined as the reverse path. Although FIG. 1 illustrates both a DOCSIS embedded Cable Modem (eCM) 12 and an OOB QPSK Modem 13, the first generation CableCARD™ receivers provided only unidirectional QPSK modems and no eCM. Products based on CableLabs® Host 2.0 specifications, are required to use M-CARDs, provide bidirectional functionality for QPSK modems, and provide DSG capability. The DOCSIS eCM 12 is another means for OOB communication between the Cable Subsystem 20 and the headend. DOCSIS upstream and downstream traffic is carried over the TCP/IP networking protocols. The software protocol stack processing may be performed by the CPU 14 within the Cable Subsystem 20. TCP/IP traffic containing OOB communications is converted into the type of signaling used by the CableCARD™ common interface.

The multiplexer 3 and de-multiplexer 4 are required when an M-CARD is used even if there is only one in-band tuner. The multiplexer 3 has three functions. The first function is to add a header that includes a Local Transport Stream ID (LTSID) to each packet in all transport streams. The LTSID associates each packet with a specific input source TS. The second function is to perform packet level multiplexing of all the transport streams. The third function is to output TS packets (including header) at the bit-rate required by the CableCARD™ interface. The motivation for such multiplexing is to limit the number of signal lines needed for the TS input and output connector pins of the CableCARD™ 19. The de-multiplexer 4 performs the inverse of the multiplexer functions.

The voltage control unit 23 under direction of the CPU 14 may provide the necessary power supply voltages to the CableCARD™ 19, when the CableCARD™ 19 is inserted in the slot 30. This arrangement allows the Cable Subsystem 20 to supply power to the CableCARD™ 19 according to the CableCARD™'s supply requirement.

The Power Supply 18 may convert AC power line distribution voltages to much lower DC voltages that are required for analog and digital signal processing circuitry. Examples of analog circuits may include the tuner 1, the video subsystem 8, and the audio subsystem 9 in FIG. 1. Examples of digital signal processing circuitry may include the CPU 6 and 14, the MPEG decoder 5, and the CableCARD™ 19 in FIG. 1. The TV Micro 15 manages the control of power generation and distribution. The TV Micro 15 may determine which subsystems within the integrated cable-ready DTV receiver are activated (powered) or placed into the de-activated (non-powered) state. When a subsystem is de-activated the power consumed by that subsystem is reduced considerably or eliminated altogether.

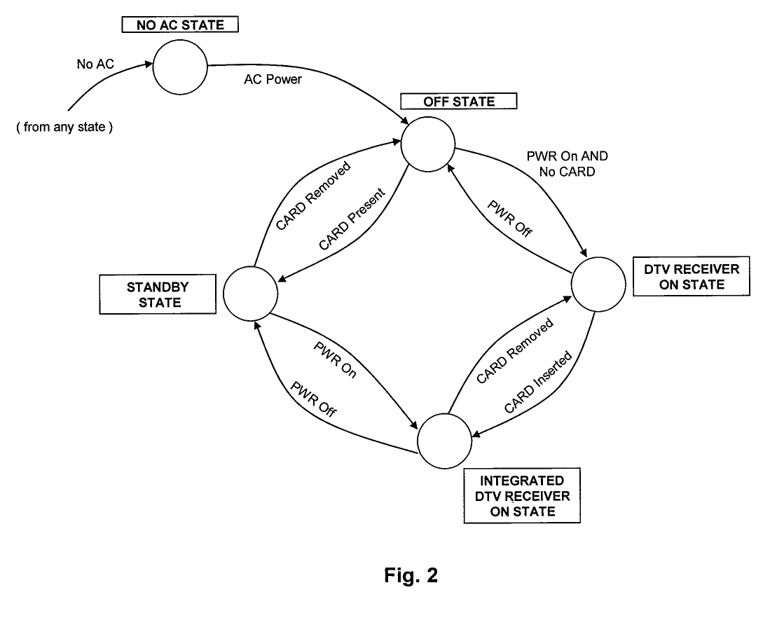

For the purposes of describing the power management method disclosed herein, the following definitions will be used for the states shown in FIG. 2:

### No AC State

No AC power is applied to the integrated cable-ready DTV receiver. There is no ability to respond to external or user initiated commands while in this state.

### Off State

The integrated cable-ready DTV receiver can only respond to the power button 16, the IR Receiver 17, and the presence or insertion of a CableCARD™ 19. If a CableCARD™ 19 is present upon entering this state, or if a CableCARD™ 19 is inserted while in this state, then there will be a transition to the STANDBY STATE. While in the OFF STATE, the power consumption is negligible as it can approach the power level that is dissipated by leakage currents. The DTV Receiver Subsystem 21, the Cable Subsystem 20, and the CableCARD™ 19 are not powered.

### Standby State

This is a minimal operational state which fulfills the OpenCable requirements as set forth in CableLabs® Host 2.0 Specifications. In this state a CableCARD™ 19 is present. Only the CableCARD™ 19 and the Cable Subsystem 20 are powered to maintain the required communications between the CableCARD™ 19 and the cable system headend. Either one-way or two-way communications can be active depending on the capabilities of the CableCARD™ 19 and the headend system.

### DTV Receiver on State

This is the normal “on” state when the integrated cable-ready DTV receiver operates without a CableCARD™ 19. The DTV Receiver Subsystem 21 is powered. The Cable Subsystem 20, and the CableCARD™ 19 are not powered (i.e., no CableCARD™ is present). This mode can be used for receiving terrestrial broadcast television programming, unencrypted cable programming, or externally sourced programming (e.g. disk or memory storage 7), which do not require CableCARD™.

### Integrated DTV Receiver on State

All the blocks shown in FIG. 1 are powered and operational. The capabilities described above under DTV RECEIVER ON STATE are available. The television receiver will also operate as a cable ready receiver to allow viewing of paid programming services available to the cable television subscriber such as encrypted cable services, VOD, and PPV.

Any product which combines elements of customarily separate autonomous systems has the potential for consuming power needlessly by allowing unused elements to be active or powered while not being used. For an integrated cable-ready DTV receiver product, the present disclosure recognizes that the receiver product may be used in two mutually exclusive modes: for example as a DTV television receiver or as an integrated cable-ready DTV receiver conforming to the OpenCable specifications developed by CableLabs®.

In the mode of operating as a DTV television receiver, the states of operation shall transition between OFF STATE and DTV RECEIVER ON STATE as shown in FIG. 2. A card detection (CDET) signal is examined to determine the presence of the CableCARD™ 19. From the OFF STATE, whenever a power on (PWR ON) signal is received and concurrently there is no CableCARD™ 19 present, then the operational state transitions to the DTV RECEIVER ON STATE. The PWR ON signal can be initiated locally by a closure of the On/Off switch 16. As an alternate means, the PWR ON signal may be produced remotely by the IR receiver 17 upon reception of the proper IR pulses which are emitted by a remote control device. The PWR ON signal may also be produced internally by a wakeup alarm timer. Under control of the TV Micro 15, the circuitry within the power supply 18 is activated to convert the incoming AC voltage to the supply voltages needed for operation by the DTV Receiver Subsystem 21. While operating in the DTV RECEIVER ON STATE, a power off (PWR OFF) signal will cause an operational state transition to the OFF STATE. All power supplied to the DTV Receiver Subsystem 21 will cease to be supplied. The power conversion process of the power supply 18, which may be typically implemented as a Pulse Width Modulated (PWM) switching regulator, is stopped to conserve power.

In the mode of operating as an integrated cable-ready DTV receiver, the states of operation that are possible are the STANDBY STATE and INTEGRATED DTV RECEIVER ON STATE as shown in FIG. 2. It should be emphasized that the OFF STATE is not allowed in order to comply with CableLabs® requirements. This specification requires that the Cable Subsystem 20 is always operational, to be continuously able to communicate with the cable company headend by receiving downstream messages and sending upstream messages. As illustrated by FIG. 2, starting initially in the OFF STATE, the TV Micro 15 examines the CDET signal line. The operational state transitions immediately to the STANDBY STATE when the CDET signal line indicates that there is a CableCARD™ 19 present. This transition is not dependant on any user interaction in the case when the CableCARD™ 19 is present upon entry into the OFF STATE. It is also possible that a user could insert a CableCARD™ 19 while in the OFF STATE. The CDET signal, monitored by the TV Micro 15, will indicate that a CableCARD™ 19 is present and the operational state transitions to the STANDBY STATE. Upon transition to the STANDBY STATE, under control of the TV Micro 15, the circuitry within the power supply 18 is activated to convert the incoming AC voltage to the supply voltages needed for operation by the Cable Subsystem 20. In turn, the CPU 14 of the Cable Subsystem 20 commands the voltage control unit 23 to switch on the appropriate supply voltages to the CableCARD™ 19. There is a state transition from the STANDBY STATE to the INTEGRATED DTV RECEIVER ON STATE when a PWR ON signal condition occurs as shown in FIG. 2. This transition causes the TV Micro 15 to command the power supply 18 to supply the required supply voltages to the DTV Receiver Subsystem 21 as well as continue to supply the supply voltages to the Cable Subsystem 20.

The above paragraphs describe state transitions that are within the two operational modes—the mode of a DTV television receiver and the mode of an integrated cable-ready DTV receiver. It is noted that the presence or absence of a CableCARD™ 19 inserted into a card receiver, for example a slot 30, provided in the integrated cable-ready DTV receiver determines the operational mode. For completeness, the present disclosure includes the transitions that are possible due to the plug-in nature of the CableCARD™ 19. The consideration of transitions based on the insertion or extraction of a CableCARD™ 19 guarantees that the integrated cable-ready DTV receiver can react properly to these asynchronous events by continuing to operate in an orderly fashion. Referring to FIG. 2, while in the DTV RECEIVER ON STATE, if a CableCARD™ 19 is inserted then the state diagram shows a transition tagged “CARD Inserted” to the INTEGRATED DTV RECEIVER ON STATE. The method of detecting that the CableCARD™ 19 was inserted is accomplished by generating an interrupt signal to the TV Micro 15 or alternately by examining the condition of the CDET signal by means of a periodically polling algorithm. By the same detecting fashions, when in the INTEGRATED DTV RECEIVER ON STATE and the “CARD Removed” signal condition is detected then the operational state transitions to DTV RECEIVER ON STATE as shown in FIG. 2. The supply voltages to the DTV Receiver Subsystem 21 and Cable Subsystem 20 are activated or de-activated accordingly as a result of the transitions between the DTV RECEIVER ON STATE and the INTEGRATED DTV RECEIVER ON STATE. Again referring to FIG. 2, a CableCARD™ being removed while in the STANDBY STATE is shown as the “CARD Removed” transition to the OFF STATE. The power supply voltages to the Cable Subsystem 20 together with the power being supplied to the CableCARD™ 19 connector slot 30 while in the STANDBY STATE are de-activated upon the transition to the OFF STATE.

To achieve an orderly start-up and shutdown, FIG. 2 shows that from any state, a no AC supply (No AC) condition will commence an orderly shutdown procedure and then transition the operational mode to the NO AC STATE. Typically, an AC voltage loss detector within the power supply 18 is used as the leading indicator to signal the No AC condition. The energy stored in the output supply voltage filtering stages of the power supply 18 is sufficient to allow the continuation of operations needed for an orderly shutdown of any active functional blocks. For the system startup case, FIG. 2 denotes the transition from the NO AC STATE to the OFF STATE upon the application of the AC power signal. A typical implementation could employ a Power-On-Reset circuit to signal the TV Micro 15. After being reset, the TV Micro 15 performs a brief initialization sequence and follows with the processing steps of controlling the state transitioning shown in FIG. 2.

The integrated cable-ready DTV receiver and the controlling method thereof disclosed herein provide numerous advantages over conventional digital TV receivers and cable STBs. Most importantly, the described integrated cable-ready DTV receiver and the controlling method thereof significantly reduce power consumption relative to the conventional receivers. The user does not need to manually turn on/off the Cable Subsystem 20. Another advantage associated with the disclosed receiver is that it provides orderly start-up and shutdown processes.

The detailed descriptions stated herein disclose one possible embodiment. Other embodiments are possible by those skilled in the art without changing the concept or scope of this disclosure. Additionally, the concepts underlying the present disclosure are not exclusively applicable to a CableCARD™ 19. Systems utilizing peripheral devices that may be inserted into a system and thereby become a component part of the system or systems having permanently resident devices but used on a part time basis during system operation can be controlled in the same fashion as disclosed by this disclosure. Similarly, any device utilized for authorization, decryption or de-scramble of information may be used instead of the CableCARD™ 19.

Further, although certain specific examples have been disclosed, it is noted that the present teachings may be embodied in other forms without departing from the spirit or essential characteristics thereof. The present examples described above are considered in all respects as illustrative and not restrictive. The patent scope is indicated by the appended claims, and all changes that come within the meaning and range of equivalency of the claims are therefore intended to be embraced therein.

We claim:

1. An integrated cable-ready digital TV receiver, comprising:
a digital TV receiver system;
a cable receiver system;
a power control system for controlling a first power supply to the digital TV receiver system and a second power supply to the cable receiver system, the power control system being configured to control the first power supply and second power supply according to a condition of the integrated cable-ready digital TV, the condition including a first condition and a second condition, wherein:
in the first condition, the power control system is configured to supply first power as the first power supply to the digital TV receiver system and not to supply second power as the second power supply to the cable receiver system, and
in the second condition, the power control system is configured to supply the first power to the digital TV receiver system and the second power to the cable receiver system.

2. The integrated cable-ready digital TV receiver of claim 1, further comprising:
a security module receiver for receiving a security module, the security module being used for authorization, decryption or de-scramble of programs processed by the cable receiver system; and
a condition detection unit for determining the conditions of the integrated cable-ready digital TV, wherein:
the condition detection unit is configured to determine that the integrated cable-ready digital TV is in the first condition when the condition detection unit fails to detect presence of the security module in the security module receiver, and
the condition detection unit is configured to determine that the integrated cable-ready digital TV is in the second condition when the condition detection unit detects presence of the security module in the security module receiver.

3. The integrated cable-ready digital TV receiver of claim 2, wherein:
the security module receiver is included in the cable receiver system, and
in the first condition, the power control system is configured to supply the first power to the digital TV receiver system, but not to supply any power to the cable receiver system.

4. The integrated cable-ready digital TV receiver of claim 2, wherein:
the security module receiver is included in the cable receiver system, and
in the first condition, the power control system is configured to supply the first power to the digital TV receiver system, but not to supply any power to the cable receiver system except minimum power for maintaining communications between the security module receiver and the condition detection unit.

5. The integrated cable-ready digital TV receiver of claim 2, wherein:
the condition detection unit is configured to determine the integrated cable-ready digital TV is in the second condition upon insertion of the security module into the security module receiver, and
the condition detection unit is configured to determine the integrated cable-ready digital TV is in the first condition upon removal of security module from the security module receiver.

6. The integrated cable-ready digital TV receiver of claim 5, wherein:
the first condition includes an off state and a digital TV receiver on state,
the second condition includes a standby state and an integrated digital TV receiver on state,
the integrated digital TV receiver changes the condition from the off state to the standby state or from the digital TV receiver on state to the integrated digital TV receiver on state upon insertion of the security module into the security module receiver or detection of the security module by the condition detection unit, and
the integrated digital TV receiver changes the condition from the standby state to the off state or from the integrated digital TV receiver on state to the digital TV receiver on state upon removal of the security module from the security module receiver.

7. A method for controlling power supply in an integrated cable-ready digital TV receiver comprising a digital TV receiver system, a cable receiver system and a power supply system, the method comprising:
detecting whether the integrated cable-ready digital TV receiver is in a first condition or in a second condition;
when the integrated cable-ready digital TV receiver is detected being in the first condition, supplying first power to the digital TV receiver system from the power supply system and not supplying second power to the cable receiver system, and
when the integrated cable-ready digital TV receiver is detected being in the second condition, supplying the first power to the digital TV receiver system and the second power to the cable receiver system from the power supply system.

8. The method of claim 7, wherein:
the integrated cable-ready digital TV receiver further comprises a security module receiver for receiving a security module, the security module being used for authorization, decryption or de-scramble of programs processed by the cable receiver system,
said detecting includes detecting presence of the security module in the security module receiver,
when the security module is not present in the security module receiver, the integrated cable-ready digital TV receiver is detected being in the first condition, and
when the security module is present in the security module receiver, the integrated cable-ready digital TV is detected being in the second condition.

9. The method of claim 8, wherein:
the security module receiver is included in the cable receiver system, and
in the first condition, the first power is supplied to the digital TV receiver system, but no power is supplied to the cable receiver system.

10. A system comprising:
a plurality of subsystems; and
a power control system configured to determine how to supply power to the plurality of subsystems according to presence of a removable device within the system.

11. The system of claim 10, wherein:
the removable device is a security device utilized for authorization, decryption or de-scramble of information.

12. The system of claim 10, wherein:
the power control system supplies power only to a part of the plurality of subsystems when the power control system fails to detect the removable device.

13. The system of claim 10, wherein:
said determination of how to supply power to the plurality of subsystems is based on the type of the removable device present within the system.

14. The system of claim 10, wherein:
the power control system supplies power to a whole of the system when the power control system detects the presence of the removable device on the system.

15. The system of claim 10, wherein said plurality of subsystems comprises:
a first subsystem; and
a second subsystem, wherein:
the power control system supplies power only to the first subsystem when the power control system fails to detect the presence of the removable device within the system, and
the power control system supplies power to the first and second subsystems when the power control system detects the presence of the removable device within the system.

16. A system comprising:
a plurality of subsystems; and
a power control system configured to dynamically change power supplied to the plurality of subsystems according to an internal status of the system.

17. The system of claim 16, wherein:
the internal status is determined by presence of a removable device within the system and the type of the removable device.

18. The system of claim 16, wherein:
the power control system dynamically changes the power supplied within the system among a fully powered state in which power is supplied to the whole system, a standby state in which power is supplied to a part of the plurality of subsystems, and a no-power state in which no power is supplied to the system except the power control system.

19. The system of claim 16, wherein:
the power control system dynamically changes the power supplied within the system according to a requirement from at least one of the plurality of the subsystems.

20. The system of claim 16, wherein:
the power control system dynamically changes the power supplied within the system according to a configuration of at least one of the plurality of subsystems.
